(19) United States
(12) Patent Application Publication
(10) Pub. No.: US 2006/0032934 A1
(43) Pub. Date: Feb. 16, 2006

(54) Non-invasive railroad attachment mechanism

(76) Inventor: David L. Reichle, Littleton, CO (US)

Correspondence Address: MARSH, FISCHMANN & BREYFOGLE LLP, 3151 SOUTH VAUGHN WAY, SUITE 411, AURORA, CO, 80014, US

(21) Appl. No.: 11/186,228

(22) Filed: Jul. 21, 2005

Related U.S. Application Data
(60) Provisional application No. 60/600,182, filed on Aug. 10, 2004.

(51) Int. Cl. B60M 1/00

(52) U.S. Cl. 238/14.05

(57) ABSTRACT

The present invention relates to a system and method for non-invasively attaching components to railroad track rails. More specifically, an anchor is provided that securely fastens to the track rail in a non-invasive manner for holding one or more components relative to a surface of the track rail. In one embodiment, the non-invasive anchor utilizes a compressive force to clamp to a flange portion of the track rail. Once securely clamped to the track rail, an adjustable track engaging member is utilized to hold a component relative to the surface of the track rail. In this regard, the track engaging member may be advanced toward the track rail to compress the component between a portion of the anchor and a surface of the track rail. In another embodiment, the anchor is adhesively attachable to a surface of the track rail.

### CROSS REFERENCE TO RELATED APPLICATIONS

This application claims priority under 35 U.S.C. 119 to U.S. Provisional Application No. 60/600,182 entitled: “Non-invasive Railroad Attachment Mechanism,” having a filing date of Aug. 10, 2004.

### FIELD OF THE INVENTION

The present invention relates to a system and method for securely attaching components to railroad track rails without affecting the structural integrity of the track rails. More specifically, an anchor is provided that securely fastens to a track rail in a non-invasive manner for holding one or more components relative to a surface of the track rail.

### BACKGROUND OF THE INVENTION

In railroad applications, it is often desirable to attach one or more components to the track rail. A non-inclusive list of such components includes communications wires (i.e., signal conductors) and track heaters. In the latter case, such track heaters are often utilized in cold weather climates at railroad switches.

Components (e.g., heaters and/or signal conductors) are often anchored directly to the track rail utilizing bolts and/or welds. In this regard, a hole may be drilled into the track rail for mounting purposes, or, a portion of the component may be welded directly to the track rail. Such interconnection techniques are generally labor intensive and require careful positioning to prevent structurally weakening the track rail. Such connection techniques can result in a stress concentration within the track rail. Further, the heat of exothermic connectors (welding) can result in a brittleness in the track rail. As will be appreciated, track rails are subjected to repeated heavy loading (e.g., railroad traffic) and areas including such stress concentrations and/or brittleness may be subject to failure.

### SUMMARY OF THE INVENTION

One objective of the present invention is to provide an anchor for holding components relative to the rail without penetrating the rail.

Another objective of the present invention is to provide an anchor for holding components relative to the rail without that may be quickly and securely attached to the rail.

The inventor of the present invention has recognized that current invasive anchoring techniques for securing components to a track rail may provide certain challenges during application in the field. Accordingly, it has been determined that passive/non-intrusive anchoring techniques that allow for quickly and correctly positioning a component relative to the track rail are desirable.

According to one aspect of the present invention, an anchor is provided that utilizes a compressive force for maintaining the anchor on the track rail. More specifically, the anchor permits interconnection to a foot of the track rail without extending beyond a centerline axis of the track rail. The anchor includes first and second members disposed in a opposing and spaced relationship. A bias force member, which provides a restoring force when deflected from a static position, interconnects the first and second members. The first member is adapted to engage a first surface of a track rail the second member is adapted to engage an opposing surface of the track rail. Typically these surface will be the top and bottom surfaces of a flange portion of the foot of a track rail. Accordingly, when a track rail is positioned between the first and second members in a manner that deflects the bias force member, the bias force member provides the restoring force that creates a compressive force between the first and second members. This compressive force maintains the anchor on the track rail. To secure a component relative to the surface of the track rail, the anchor further includes an track engaging member that is selectively positionable relative to the anchor. The first and second members are adapted to engage opposing surfaces of the track rail wherein the opposing surfaces are on a common half of the track rail. That is, the anchor may be designed such that no portion of the anchor extends past a mid line of the track rail as defined by the web of the track rail.

The anchor may be designed in any manner that allows the first and second members to compressively engage opposing surfaces of the track rail. In one embodiment, the first and second members along with the bias force member define a substantially U-shaped member. Accordingly, a portion of the track rail, such as the flange, may be disposed within the slot defined by the U-shaped member. To facilitate biasing of the bias force member, the slot defined by the U-shaped member may be tapered. Accordingly, by driving a portion of the track rail into the tapered slot the bias force member may be deflected from a static position. To further facilitate such biasing, a strike plate may be incorporated onto a bottom surface of the U-shaped member. This may allow an installer to strike the anchor in order to drive the track rail between the first and second members.

The bias force member may be a separately formed member that interconnects the first and second members. In another arrangement, the first member, second member and the bias force member may be an integrally formed unit. In either arrangement, the bias force member acts effectively as a spring that interconnects the first and second members. As will be appreciated, the restoring force (i.e., compressive force) provided by the bias force member may be selected in accordance with design requirements. For instance, one or more physical parameters of the bias force member may adjusted to, for example, stiffen the bias force member such that is may provide an enhanced compressive force between the first and second members if so desired.

The first and second opposing members may be spaced between about 1 cm and 4 cm centimeters apart. In this regard, the first and second members are adapted to engage the flange of most track rails. However, it will be appreciated that other arrangements are possible.

In order to maintain the anchor on the track rail, one or both of the opposing members may further include teeth that are operative to engage the surface of the track rail. In this regard, the teeth may have a hardness that is greater than the hardness of the track rail to facilitate engagement therewith. Such teeth may be separately formed and interconnected to the opposing members or, the teeth may be integrally formed within the opposing members. For instance, in one arrangement teeth may be laser cut into the opposing surfaces. Furthermore, such integrally formed teeth may be hardened after being formed within the opposing members.

As noted, the track engaging member allows for securing a component relative to the surface of a track rail. In this regard, the track engaging member is movable relative to the anchor after it is interconnected to the track rail to, for example, apply a compressive force between a portion of the track engaging member and a surface of the track rail. The compressive force may be utilized to hold a component between the adjustor and the surface of the track rail. In one arrangement, the track engaging member includes a threaded bore and a threaded element that is selectively positionable relative to the threaded bore. The threaded bore may extend through any portion of the anchor. Alternatively, the threaded bore may extend through an element that is interconnected to the anchor. In one arrangement, a block assembly having a threaded bore is attached to the anchor. For instance, the block assembly may comprise a threaded nut that is press fit into the anchor.

In any case, the threaded element (e.g., a bolt) may be threaded relative to the threaded bore such that a tip of the threaded element may be advanced/retracted relative to a surface of the track rail. Further, the block assembly may include multiple threaded bores to allow for selectively positioning the threaded element relative to different surfaces of the track rail. For instance, a first bore may allow for advancing the threaded element relative to a top surface of the foot of the track rail while a second bore may allow for advancing the threaded element relative to the web of the track rail.

According to a second aspect of the present invention, a non-invasive anchor that is releaseably attachable a flange of a track rail is provided. The anchor includes a body that defines a slot between first and second surfaces and a retention element. The retention element is selectively positionable through a portion of the body into the slot for engaging a member (i.e., track rail) disposed between the first and second surfaces. Additionally, the anchor includes a track engaging member that is selectively positionable relative to the body of the anchor that may be utilized to hold a component relative to the surface of a track rail. Typically, the slot is sized to receive a flange of the foot portion of most standard track rails. Furthermore, the depth of the slot may be designed to prevent the anchor from extending past the midpoint of the track rail.

The retention element may be any element that maintains the track rail within the slot of the anchor. In one embodiment, the retention element is formed of a threaded element (i.e., set screw) that is selectively positionable through a threaded bore that extends through a portion of the body into the slot. This set screw may have a pointed tip that may allow the tip to better engage the surface of the track rail. Accordingly, the, the setscrew may have a hardness that is in excess of that of the track rail.

According to another aspect of the present invention, an adhesively attachable anchor is provided for securing components to a track rail. The anchor includes a first surface adapted for adhesive attachment to a first portion of a track rail and a second surface adapted for adhesive attachment to a second portion of a track rail. An adjustor is positioned between the first and second surfaces that is selectively positionable relative to the anchor. The adjustor may be utilized for holding a component relative to the surface of a track rail.

Typically, the body of the anchor will be substantially U-shaped or V-shaped between the first and second surfaces. As discussed above, the track engaging member may utilize one or more threaded bores and a threaded retention element to selectively hold a component relative to the surface of the track rail.

The first and second surfaces may be adapted to attach to a common surface of the track rail. For instance, the first and second surfaces may each be adapted for attachment to the flange portion of the track rail. In this regard, the first and second surfaces may define first and second surface that are disposed in a substantially common plane. Alternatively, these first and second surfaces may be adapted to interconnect to transverse surfaces. For instance, the first surface may be adapted to be adhesively attached to a web portion of the track rail while the second surface is adapted to be attached to a portion of the flange. In this regard, planes defined by the first and second surfaces may be transverse.

According to another aspect of the present invention, an anchor is provided for attaching components to a track rail. The anchor includes a body having a first contact surface for engaging a first surface of the track rail and a second contact surface for engaging a second surface of the track rail. A compressive force member is utilized to apply a compressive force between the first and second contact surfaces. Additionally, at least one of the contact surfaces includes a recess that allows a component to be disposed between the contact surface and the surface of the track rail when the anchor is attached thereto.

In one arrangement, the anchor of the present aspect includes a bore extending through the body of the anchor and into the recess. An adjustable element is selectively advanceable/retractable through the bore. This adjustable element may be utilized to engage a component disposed within the recess and thereby secure the component relative to the track surface. In one arrangement, the adjustable element comprises a threaded bolt.

In one arrangement, the compressive force member comprises a bias force member that acts as a spring to apply compressive force between the first and second contact surfaces. In another arrangement, the compressive force member comprises a threaded element that allows for selectively adjusting a distance between the first and second contact surfaces.

The anchor may be adapted to apply compressive forces to different surfaces of the track rail. For instance, in one arrangement the first and second contact surfaces may contact the top and bottom surfaces of a single flange of the track rail. In another arrangement, the first and second contact surfaces may contact the opposing outside edges of opposing flanges of the track rail.

In another aspect of the present invention, a method for non-invasively attaching a component to a track rail is provided. The method includes the step of positioning a flange of a track rail between first and second opposing surface of an anchor assembly and applying a compressive force between the first and second members to anchor the opposing members to the track rail. Once so anchored, a component may be positioned on a surface of the track rail in proximity to the anchor assembly. A track engaging member associated with the anchor assembly may then be utilized to engage the component and hold the component relative to the surface of the track rail.

Additional objectives and advantages of the present invention will be apparent upon consideration of the present disclosure.

### BRIEF DESCRIPTION OF THE DRAWINGS

For a more complete understanding of the present invention and further advantages thereof, reference is now made to the following Detailed Description taken in conjunction with the drawings in which:

FIG. 1 is a perspective view showing a railroad track switch;

FIG. 2 shows perspective view of a first embodiment of a non-invasive anchor;

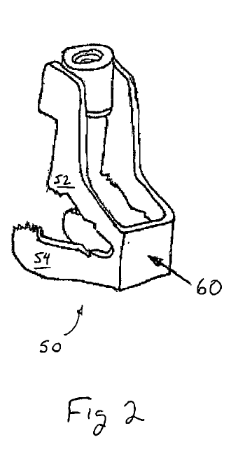

FIG. 3 shows the anchor of FIG. 2 applied to a track rail;

FIG. 4 shows a removable connector of the anchor of FIG. 2 attached to a track rail once the anchor is removed;;

FIG. 5 shows a second embodiment of a non-invasive anchor;

FIG. 6 shows a third embodiment of a non-invasive anchor;

FIG. 7 shows a fourth embodiment of a non-invasive anchor;

FIG. 8 shows a fifth embodiment of a non-invasive anchor;

FIG. 9 shows a sixth embodiment of a non-invasive anchor; and

FIG. 10 shows a seventh embodiment of a non-invasive anchor.

### DETAILED DESCRIPTION

The present invention is directed to various anchoring/clamping mechanisms that permit non-invasively holding a component relative to the surface of a railroad track rail. The anchoring mechanisms are operable to hold a variety of different components relative to the surface of such track rails. However, in the following description the invention is set forth primarily in the context of non-invasively holding a heater element and/or a signal line/conductor relative to the surface of a track rail. It will be appreciated, however, that certain aspects of the invention are not limited to such applications.

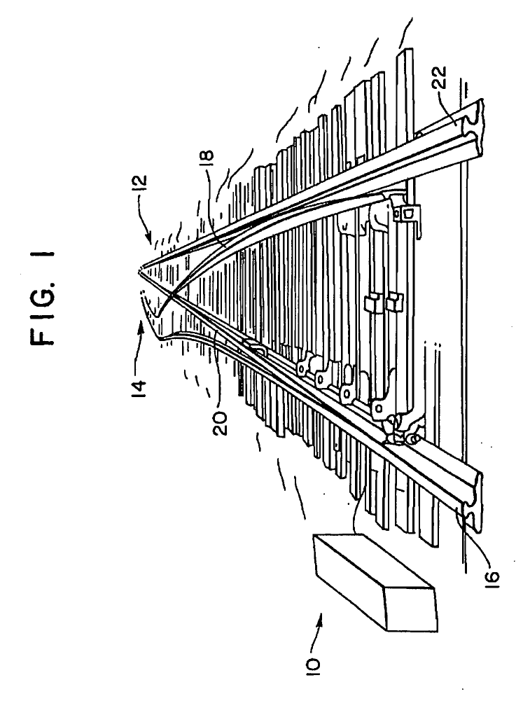

Referring to FIG. 1, a railroad track switch is generally identified by the reference numeral 10. The track switch 10 is used, for example, to switch train traffic between first 12 and second 14 tracks. Generally, the switch 10 includes a pair of fixed rails 16 and 22 and a pair of switching rails 18 and 20.

The switching rails 18 and 20 are positioned on the gauge (inner) side of each of the fixed rails 16 or 22 and are movable between reverse and normal positions. In FIG. 1, the first switching rail 18 is disengaged from the first fixed rail 22 and the second switching rail 20 is engaged to the second fixed rail 16. In this configuration, the switch 10 is set to select the first track 12. To select the second track 14, the switching rails 18 and 20 can be shifted in unison to the right, as viewed in FIG. 1, so that the first switching rail 18 abuts the first fixed rail 22 and the second switching rail 20 is disengaged from the second fixed rail 16.

It will be appreciated that proper operation requires good contact between the fixed rail 22 and switching rail 18 in the reverse position and between the fixed rail 16 and switching rail 20 in the normal position. Use of a heater in the switching area is desirable to reduce or substantially eliminating build up of ice or snow at the switch interface. Such a heater is set forth in U.S. Pat. No. ______ entitled “______” the contents of which are incorporated herein by reference.

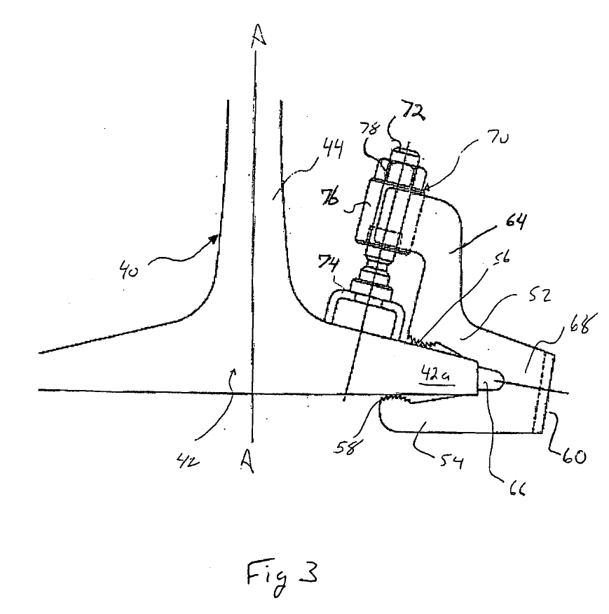

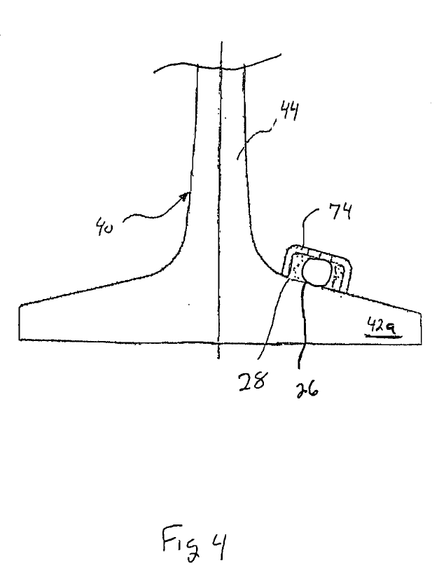

FIGS. 3-4B show a first embodiment of a noninvasive anchor 50 that may be utilized for holding a component to a surface of a railroad track rail 40. The anchor 50 applies a compressive force between opposing members to secure the anchor 50 to the track rail 40. In this regard, no significant penetration into the track rail 40 is required. In addition, the anchor 50 includes a track engaging member 70 for use in selectively compressing a component, such as a heater or signal conductor, against the surface of the track rail 40. In the present embodiment, the anchor 50 includes opposing jaws 52, 54 for engaging top and bottom surfaces the foot 42 of the track rail 40. As shown, the opposing jaws 52, 54 define a receiving slot 66 that is sized to receive a flange portion 42a of the foot 42 of the track rail 40. Of note, the slot 66 is sized to prevent the anchor from extending beyond a centerline axis A-A′ of the track rail 40. See FIG. 3. As will be appreciated in some instances track rails do not contain two opposing flanges. For instance, switching rails at a track switch may have a reduced cross-sectional profile (e.g., a single flange). Accordingly, the anchor 50 allows for attaching components to such rails.

In application of the anchor 50 to the track rail 40, a flange 42a is disposed within the slot 66. As shown, the noninvasive anchor 50 also includes a strike surface 60 to facilitate such disposition. An installer may hit the strike surface 60 using, for example, a hammer to drive the flange 42a into the slot 66. As noted, the anchor 50 applies a compressive force between the opposing jaw members 52, 54 to maintain the anchor 50 on the track rail 40. Specifically, a body portion 68 interconnecting the first and second jaws 52, 54 acts as a bias force member (e.g., a spring). As will be appreciated, driving the flange 42a into the slot 66 spreads the jaw members 52, 54 such that the body portion 68 deforms. At least a portion of this deformation is elastic deformation such that the body portion 68 of the anchor 50 attempts to regain its previous form. That is, the body portion 68 acts as a bias for member that provides a restoring force that attempts to return the jaw members 52, 54 to a static position, thereby providing a compressive force between those members 52, 54.

In order to maintain the anchor 50 on the generally tapered flange 42a, the opposing jaws 52, 54 further include teeth 56, 58, respectively. These teeth 56, 58 are designed to form an effective engagement with surface of the track rail 40 such that the noninvasive anchor 50 resists removal from the track rail 40. Upon initial attachment to the track rail 40, the teeth 56, 58 may rest on the surface of the track rail 40. However, during the vibratory loading associated with trains utilizing the track 40, the teeth 56, 58 may, over time, slightly penetrate the track rail 40. As will be appreciated, the location and minimal entry of the teeth into the track rail 40 does not significantly affect the structural integrity of the track rail 40.

It may be preferred that the teeth 56, 58 have a hardness in excess of that of the track rail 40 to allow the teeth 56, 58 to effectively grip the track rail 40. As will be appreciated, different portions of the track rail 40 may have different hardnesses. Accordingly, it will be appreciated that the hardness of the teeth 56, 58 need only be greater than the portion of the track rail 40 to which they are designed to engage (e.g., the flange 42a). In one embodiment, the teeth 56, 58 have a Rockwell hardness of at least about of at least about 35. However, this is not a requirement.

Though the entire anchor 50 may have a hardness in excess of the track rail 40, in a preferred embodiment only the teeth 56, 58 are hardened. In one arrangement, the teeth 56, 58 may be made a different material than of the rest of the anchor 50. For example, the teeth 56, 58 may individually formed and subsequently attached to the anchor 50. Alternatively, the teeth 56, 58 may be integrally formed within the anchor 50 and hardened thereafter utilizing any appropriate hardening method. In one embodiment, the teeth are laser cut 56, 58 into the surface of the opposing jaw members 52, 54 prior to hardening.

As shown in FIG. 3, the track engaging member 70 allows for selectively positioning a holding bracket 74 relative to a top surface of the flange 42a using a treaded element 72. This allows for securely pressing a component, such as a heater or signal line, relative to a surface of the track rail 40. Though the holding bracket 74 is shown as being substantially U-shaped, it will be appreciated that the holding bracket 74 may be otherwise shaped to, for example, accommodate differently shaped components. Additionally, the inside surface of the bracket 74 may include a spring (e.g., a leaf spring not shown) for applying additional compressive force between the bracket 74 and a component held there beneath. Further, the holding bracket may be removable from the threaded element 72. See FIG. 4. In this regard, if the anchor 50 is utilized to hold a signal line 26 to the surface of the track rail 40 while an electrically conductive 28 adhesive cures, the holding bracket 74 may be adhered to the track rail 40 along with the signal line 26. Accordingly, removable connection of the holding bracket 74 permits the threaded element 72 to be retracted such that the anchor 50 may be removed from the track rail 40 and re-used (e.g., with a replacement holding bracket 74).

As noted, the position of the holding bracket 74 is adjustable utilizing a threaded element 72 (e.g., bolt). The threaded adjuster 72 in the embodiment shown may be selectively threaded into an adjuster block 76 having a threaded bore. Accordingly, by selectively threading the threaded adjuster 72, the position of the holding bracket 74 may be moved up/down relative to the surface of the track rail 40. Furthermore, the track engaging member 70 includes a set nut 78 for locking the threaded adjuster 72 in a desired position.

In order to provide a desired clearance between the track engaging member 70 and the surface of the track rail 40 to allow positioning of components therebetween, the physical configuration of the anchor 50 may be altered. For instance, the length of a neck section 64 of the anchor 50 may be increased. That is, by increasing the length of the neck section 64 additional clearance may be provided between the anchor 50 and the top surface of the foot 42 of the track rail 40 to allow for attaching larger components to the track rail 40.

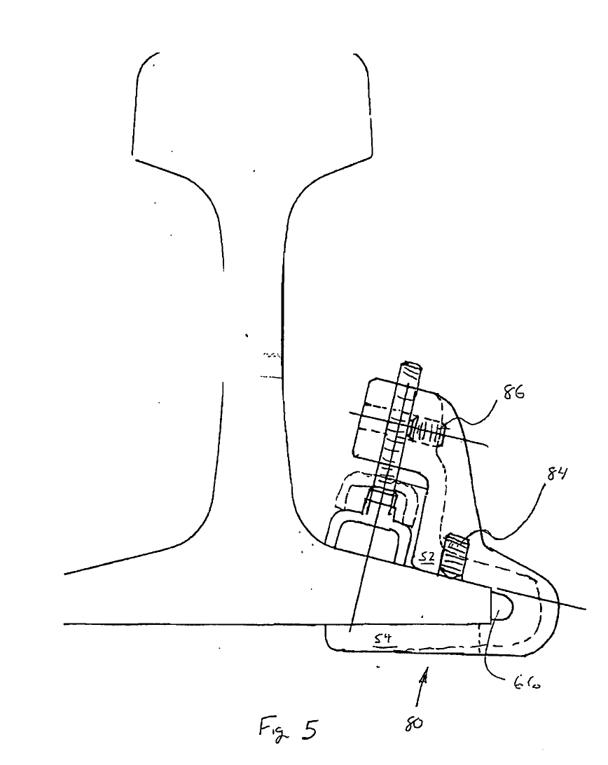

Variations to the noninvasive anchor 50 as described above will become apparent to those skilled in the art. For instance, the noninvasive anchor 80 of FIG. 5, while sharing many of the attributes with the anchor 50 of FIG. 3, does not utilize compressive force between opposing jaws to hold the anchor 80 on the flange 42a. Rather, the noninvasive anchor 150 utilizes a set screw 84 that may be selectively disposed through a threaded aperture that extends through one of the jaw members 52, 54 into the slot 66. Accordingly, the set screw 84 may engage a surface of the track rail 40. In one embodiment, the set screw 84 may be pointed and/or have a hardness in excess of that of the track rail 40. Furthermore, the embodiment of FIG. 5 utilizes a set screw 86 for maintaining the track engaging member 70 at a desired position.

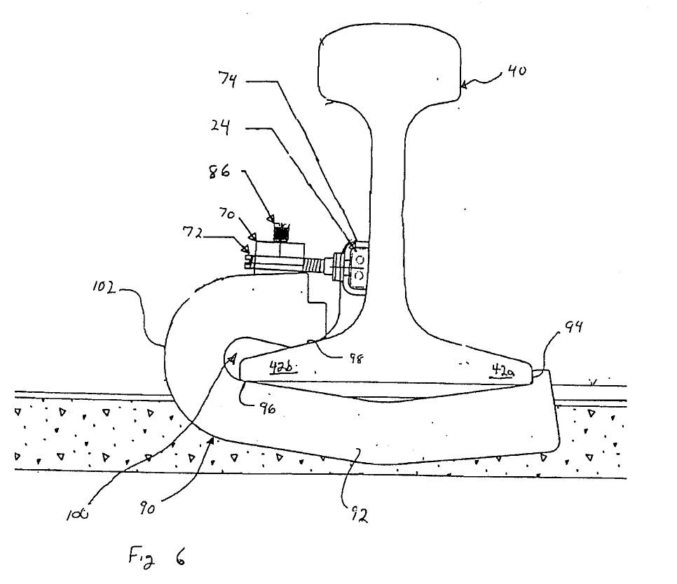

FIG. 6 shows another embodiment of a noninvasive anchor 90. As shown, this noninvasive anchor 90 is a wraparound anchor that extends across the bottom of the track rail 40 to engage the both flanges 42a, 42b of the foot 42 of the track rail 40. In this regard, a body 92 of the anchor 90 includes a first flange contact surface 94, a fulcrum surface 96 and a second flange contact surface 98 for contacting a top surface of the foot 42. The wraparound anchor 90 may be applied to the track rail 40 by disposing a flange 42b into slot 100 and striking the end 102 of the anchor 90. This has the effect of driving the flange 42b into slot 100 such that the first flange contact surface 94 may extend over the end of flange 42a. When applied to the track rail 40, a compressive force is applied between the second flange contact surface 98 and the fulcrum surface 96 that maintains the anchor 90 on the rail 40. The wraparound anchor 90 also incorporates a track engaging member 70 for use in holding a component 24 relative to the web 44 of the track rail 40. As shown, the track engaging member includes a threaded bore, a threaded element 72, a set screw 86 and a bracket 74. As shown, the bracket 74 is advanced toward the web of the track rail 40 to compress a heater element 24 to the track rail 40.

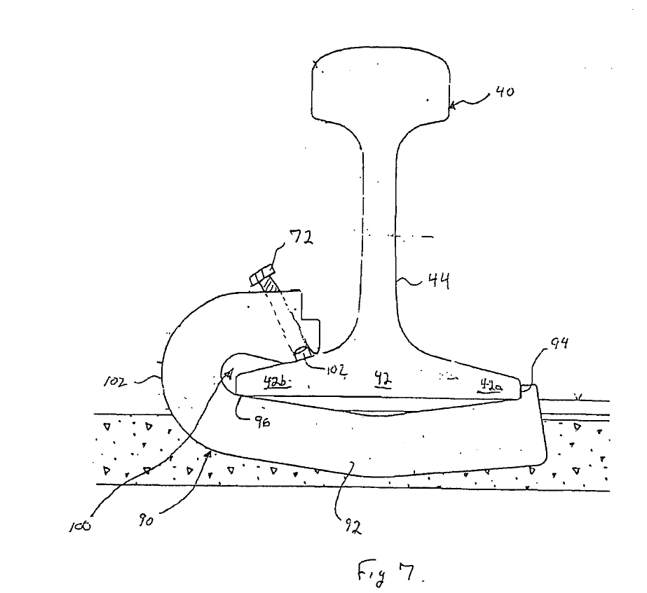

FIG. 7 shows an alternate embodiment of the wraparound anchor 90. In this embodiment, the track engaging member is a threaded element 72 that extends though a bore through the body 92 of the anchor 90. The bore exits the body through the second flange contact surface 98. The second flange contact surface 98 includes a recess 102 that is sized to receive a signal line (not shown). In this regard, a conductive portion of a signal line may be disposed within the recess 102, between the anchor and the flange 42a and the threaded element 72 may be advanced to compress the signal line against the top surface of the track rail 40.

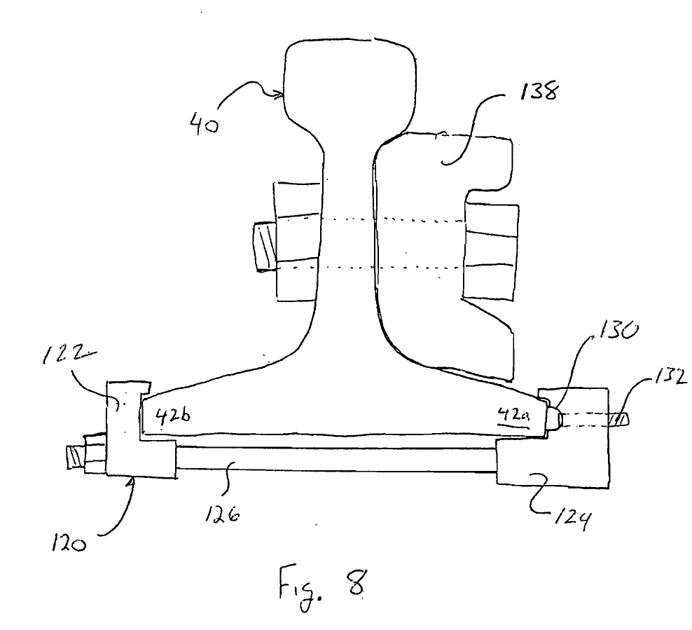

FIG. 8 illustrates a non-invasive flange anchor 120. As shown, the anchor 120 is adapted to hold a component such as a signal line relative to an edge surface of a flange 42a of the track rail 40. Such an anchor 120 may be particularly useful for attaching signal lines to track rails at track rail splices where two track rails abut. Generally, it is desirable to electrically interconnect such abutting rack rails using a signal line. However, at such locations a splice bar 138 may extend between the interface of the abutting track rails. Such splice bars 138 may be bolted to one or both sides of the web of the abutting track rails. As shown, this may prevent attaching a component such as a signal line to the track rail 40 on the top surface of the foot and/or to the web of the track rail. Accordingly, the flange anchor 120 provides a convenient mechanism for holding a component to a surface of a flange 42a.

The flange anchor 120 includes first and second shackles 122, 124 and a threaded adjustor 126. As shown, the threaded adjustor 126 is fixedly connected to shackle 124 and extends through shackle 122. Adjustment of nut 128 moves shackle 122 to increase/decrease the distance between the two shackles 122, 124. The shackles 122, 124 each include a track engaging surface adapted to contact the outside surfaces of the flanges 42a, 42b. The track engaging surface of at least one shackle also includes a recess 130 for use in holding a component against the outside surface of the flange. Each shackle also includes a lip that extends inwardly from the track engaging surface. Upon application to a track rail, these lips extend over a top surface of each flange 42a, 42b.

As noted, at least one of the shackles 122, 124 includes a recess 130 to hold a component to an outside surface of a corresponding flange 42a, 42b. In one embodiment, this recess 130 is sized to permit a signal wire to be disposed between the surface of the flange 42a and the shackle 124. Once so disposed, a threaded set screw 132 may be utilized to press the signal line against the surface of the flange 42a. In one arrangement, an electrically conductive adhesive may be applied to the signal line and or the surface of the flange 42a. To facilitate removal of the anchor after the adhesive has cured, the flange anchor may include a removable recess liner, e.g., a half cylinder, (not shown). Such a removable recess liner may function similar to the bracket 74 of FIG. 4. This may permit removal of the flange anchor 120 once a signal line has been adhered to the flange 42a.

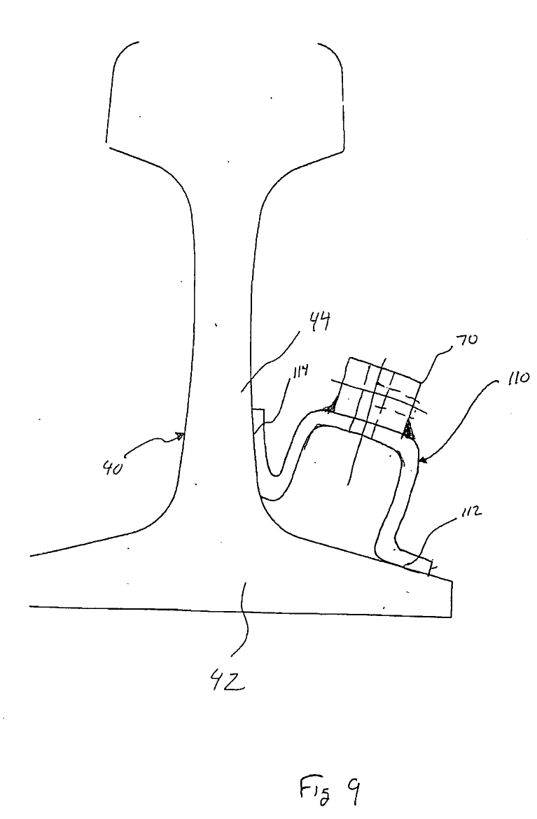

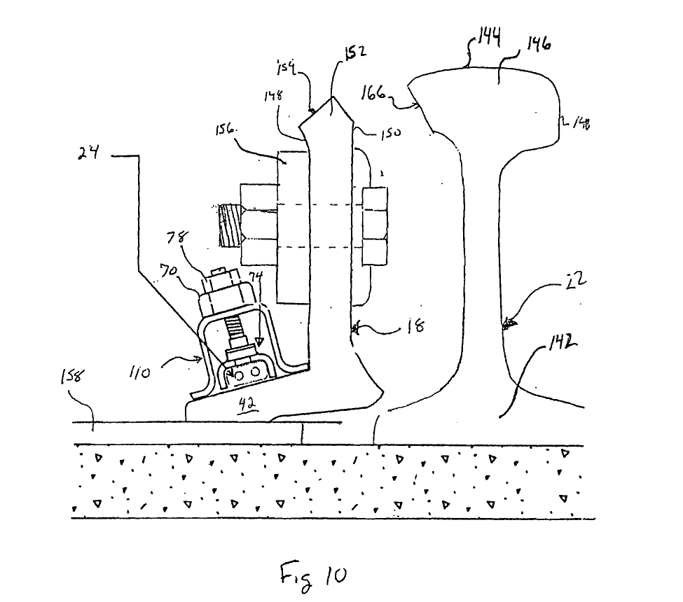

FIGS. 9 and 10 illustrate further embodiments of a noninvasive anchor 110 that may be utilized to hold components relative to the track rail 40. This noninvasive anchor 110 is adapted to be adhesively secured to the surface of the track rail 40. In this regard, the anchor 110 includes a first contact surface 112 adapted for engaging a first portion of the track rail 40 and a second contact surface 114 adapted for contacting a second portion of the track rail 40. As shown, one of these surfaces, e.g., 114, may be adapted to engage a portion of the web 44 while a second surface 112 may be adapted to engage a portion of the foot 42. See FIG. 9. Alternatively, both contact surfaces 112, 114 may be adapted to contact a common surface of the track rail 40. See FIG. 10. In either case, the adhesively attachable noninvasive anchor 110 is generally U-shaped between the first and second contact surfaces. Disposed between the first and second contact surfaces 112, 114 is a track engaging member 70. As with the previously discussed anchors, the track engaging member 70 may include a threaded bore for receiving a threaded adjuster that, as above, may be utilized to adjust the position of a holding bracket utilized to maintain a component relative to the surface of the track rail 40. As shown, the track engaging member 70 further includes a set nut 78 for maintaining the position of a threaded adjuster in a desired position relative to the track rail 40.

To enhance the interconnection between the adhesively attachable anchor 110 and the track rail 40, surface preparation may be required. That is, surface coatings and/or oxidation (e.g., rust) may be removed from the surface of the track rail 40 prior to adhering the anchor 110 thereto. In one application an abrasive disk may be utilized to clean the surface of the track rail. After such abrasive cleaning, the surface may be washed (e.g., using alcohol) to remove further debris. An adhesive, such as an epoxy, may then be applied to the surface of the track rail 40 and/or to the contact surfaces 112, 114 of the anchor 110. The anchor 110 may then be contacted with the track rail 40. Typically, the adhesive will require a predetermined cure period to effectively attach the anchor 100 to the track rail 40. Once so attached, the anchor 110 may be utilized to hold components against the surface of the track rail.

FIG. 10 shows a fixed rail 22 and switching rail 18 in a disengaged position. The fixed rail 22 includes a gauge side 166 for engaging the flange of a train wheel, a field side 140, a head flange 146 including wheel-bearing surface 144, and a mounting flange 142 for staking to underlying railroad ties. Similarly, switching rail 18 includes a gauge side 148 for engaging the flange of a train wheel, an opposite side 150, head flange 152 including wheel bearing surface 154, and mounting block 156 that extends along the switching rail 18 and which mounts the switching rail 18 to a moveable actuator arm 158. The switching rail 118 is moveable between engaged and disengaged positions by manual or motor driven operation of the actuator arm 158. In the engaged position, the opposite side 150 of switching rail 18 closely abuts against the gauge side 126 of fixed rail 22 in the vicinity of the head flanges 146 and 152.

As will be appreciated, attachment of the mounting block to the vertical surface of the switching rail 18, prevents attachment of a heater element to that vertical surface. Accordingly, the flange 42 of the switching rail 118 provides the only available surface to which a heater may be directly applied to the switching rail. However, the interconnection of the switching rail 118 to the actuator arm 158 and the reduced structure of the switching rail 118 prevents use of wrap-around anchors to hold components relative to the switching rail foot 40. Furthermore, in addition to a general desire to avoid penetrating the reduced rail structure, the limited clearance between the actuator arm 158 and, for example, rail ties, may prevent directly bolting components to the switching rail. In this regard, the adhesively attachable anchor 110 allows for securely and non-invasively attaching a heater 24 to the flange 40 the switching rail 18.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. For instance, the anchors described above may include two or more threaded bores that allow a threaded adjuster to be selectively positioned against the different track rail surfaces. As will be appreciated, this may provide a single anchor that is operative to hold different components relative to different portions of the track rail. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

What is claimed:

1. An anchor for attaching components to a track rail, comprising:
a first member adapted to engage a top surface of a track rail;
a second member disposed in a spaced and opposing and relationship to said first member, said second member being adapted to engage an opposing bottom surface of said track rail;
a bias force member interconnected to said first and second members, wherein said bias force member provides a restoring force when deflected from a static position;
a track engaging member selectively positionable relative to said anchor for holding a component relative to a surface of said track rail, wherein no portion of said anchor extends beyond a centerline plane of a track rail when said anchor is applied thereto.

2. The anchor of claim 1, wherein opposing surfaces of said first member and said second member are spaced between about 1 cm and 4 cm apart.

3. The anchor of claim 1, wherein said first member, said second member and said bias force member define a substantially U-shaped member.

4. The anchor of claim 3, further comprising:
a striking surface on a bottom portion of said substantially U-shaped member.

5. The anchor of claim 3, further comprising:
a set screw for selectively positioning through a threaded bore extending though said U-shaped member into a slot defined by said U-shaped member.

6. The anchor of claim 1, wherein at least one of said first and second members further comprises:
teeth positioned on a surface opposing the other of said first and second members.

7. The anchor of claim 6, wherein said teeth have a Rockwell hardness of at least about 35.

8. The anchor of claim 6, wherein said teeth are integrally formed in said surface.

9. The anchor of claim 1, wherein said track engaging member comprises:
a threaded element selectively positionable relative to a threaded bore extending through a portion of said anchor.

10. The anchor of claim 9, further comprising: first and second threaded bores.

11. An anchor for attaching components to a track rail, comprising:
a body defining a slot between a first surface and a second surface;
a retention element selectively positionable through a portion of said body into said slot for engaging a member disposed between said first and second surfaces; and
a track engaging member selectively positionable relative to said body of said anchor for holding a component relative to a surface of said track rail.

12. The anchor of claim 11, wherein said slot has a width between about 1 cm and 4 cm.

13. The anchor of claim 11, wherein said slot is substantially U-shaped.

14. The anchor of claim 10, wherein said retention element comprises a threaded element that is selectively positionable through a threaded bore.

15. The anchor of claim 14, wherein said threaded element includes a pointed tip for engaging a member disposed between said first and second surfaces.

16. The anchor of claim 14, wherein said track engaging member comprises:
a threaded element selectively positionable relative to a threaded bore extending through a portion of said anchor.

17. A method for attaching components to a track rail, comprising:
positioning a portion of a track rail between first and second opposing surfaces of an anchor;
compressing said portion of said track rail between said first and second opposing surfaces;
positioning a component relative to a surface of said track rail;
engaging said component with an adjustable member associated with said anchor, wherein said adjustable member compresses said component against said surface of said track rail.

18. The method of claim 17, wherein compressing comprises compressing opposing surfaces of a single flange of said track rail.

19. The method of claim 17, wherein engaging comprises advancing said adjustable member relative to said surface of said track rail.

20. An anchor for attaching components to a track rail, comprising:
a body,
a first contact surface on said body for engaging a first surface of a track rail;
a second contact surface on said body for engaging a second surface of said track rail;
a compressive force member for applying a compressive force between said first and second contact surfaces; and
a recess in at least one of said first and second contact surfaces, wherein a component may be disposed within said recess between said contact surface and a surface of said track rail.

21. The anchor of claim 20, further comprising:
a bore extending through said body and into said recess; and
an adjustable element disposed through a bore for selective advancement and retraction relative to said recess.

22. The anchor of claim 21, wherein said adjustable element comprises a threaded element.

23. The anchor of claim 20, wherein said compressive force member comprises a bias force member.

24. The anchor of claim 20, wherein said compressive force member comprises a mechanical adjustor for adjusting a distance between said first and second contact surfaces.

25. The anchor of claim 24, wherein said mechanical adjustor comprises a threaded element.

26. The anchor of claim 20, wherein at least one of said first and second contact surfaces is adapted to engage an outside edge of a flange portion of a track rail.

27. The anchor of claim 26, wherein contact surface adapted to engage an outside edge of a flange portion of a track rail comprises said recess.
